(19) United States
(12) Patent Application Publication
(10) Pub. No.: US 2009/0132947 A1
(43) Pub. Date: May 21, 2009

(54) DISPLAY DEVICE FOR HAVING THE FUNCTION OF EDITING RECORDED DATA AND METHOD FOR CONTROLLING THE SAME

(76) Inventor: Seong Woon Seol, Daegu (KR)

Correspondence Address: KED & ASSOCIATES, LLP, P.O. Box 221200, Chantilly, VA, 20153-1200, US

(21) Appl. No.: 12/299,076

(22) PCT Filed: May 2, 2007
(86) PCT No.: PCT/KR2007/002150

§ 371 Date: Oct. 30, 2008

(30) Foreign Application Priority Data
May 2, 2006 (KR) 10-2006-0039722

(51) Int. Cl. G06F 3/048

(52) U.S. Cl. 715/772

(57) ABSTRACT

The present invention relates to a display device having a function of editing recorded data and a method for controlling the same. The method comprises the steps of receiving a command for executing the recorded data editing function, displaying a progressive bar for at least two recorded data and a progressive bar for an edited recorded data to be newly created, selecting editing sections for the at least two recorded data, and inserting the selected editing section in the progressive bar for the edited recorded data to be newly created.

### TECHNICAL FIELD

The present invention relates to a display device, and more particularly, to a display device having a function of editing recorded data and method for controlling the same.

### BACKGROUND ART

Generally, the technological development of a display device such as a TV, a DTV, a PVR (personal video recorder), a DVR (digital video recorder) and the like enables the display device to be provided with various functions.

For instance, the display device has not only a function of outputting A/V data transmitted via broadcasting or, A/V data transferred from an external device but also a function of storing the A/V data.

Moreover, as a size of a memory built in the display device or an external memory size exponentially increases, a size of data storable in the display device tends to increase rapidly.

So, many efforts are made to the technology of managing numerous data stored in the display device and editing the data into user-specific data.

FIG. 1 is an exemplary diagram of an editing image of a display device having a function of editing recorded data according to a related art.

An editing image of a display device having a function of editing recorded data according to a related art is explained with reference to FIG. 1 as follows.

In the related art, in case that a user attempts to edit recorded data previously stored in a display device into a specific style, a data stream for one recorded data, as shown in FIG. 1, is displayed as a progressive bar only.

In this case, if the user selects a section to edit with reference to the displayed progressive bar for the one recorded data, the related art display device simply has a function of separately storing the selected editing section or a function of collectively using a video filter for the selected editing section.

However, the related art display device having the function of editing the recorded data and the method for controlling the same have the following problems.

First of all, the related art display device is capable of editing one recorded data only each time. Even if it is capable of editing a plurality of recorded data, it is very inconvenient to edit a plurality of the recorded data simultaneously.

Secondly, the number of previously recorded data to be edited in the related art display device is very limited.

Thirdly, since the related art display device includes a function of cutting and storing a specific part of a prescribed recorded data only, a user is unable to implement various user-specific editing functions.

### DISCLOSURE OF THE INVENTION

### Technical Solution

Accordingly, the present invention is directed to substantially obviate one or more of the problems due to limitations and disadvantages of the related art. An object of the present invention is to provide a display device having a function of editing recorded data and method for controlling the same, by which a plurality of recorded data can be edited in a simple manner with a simple manipulation.

Another object of the present invention is to provide a display device having a function of editing recorded data and method for controlling the same, by which a user can select more previous recorded data to edit.

Another object of the present invention is to provide a display device having a function of editing recorded data and method for controlling the same, by which various editing functions specified by a user can be implemented.

To achieve these and other advantages and in accordance with the purpose of the present invention, as embodied and broadly described, in controlling a display device capable of recording data, a method of controlling the display device having a recorded data editing function, includes the steps of receiving a command for executing the recorded data editing function, displaying a progressive bar for each of at least two recorded data and a progressive bar for an edited recorded data to be newly created, selecting editing sections for the at least two recorded data, respectively, and inserting the selected editing section in the progressive bar for the edited recorded data to be newly created.

Preferably, the step of displaying the progressive bar for each of the at least two recorded data and the progressive bar for the edited recorded data to be newly created is characterized in displaying the progressive bars on one image simultaneously.

Preferably, the step of selecting the editing sections for the at least two recorded data respectively can be controlled by an ‘arrow’ key button and a ‘confirm’ key button of a remote controller only.

Preferably, the step of inserting the selected editing section in the progressive bar for the edited recorded data to be newly created further includes the step of if the selected editing sections are overlapped on the progressive bar for the edited recorded data to be newly created, displaying an image for selecting a fade in/out function or an overlap editing function.

Preferably, the step of displaying the progressive bar for each of the at least two recorded data and the progressive bar for the edited recorded data to be newly created includes the step of displaying a still image corresponding to the progressive bar.

To further achieve these and other advantages and in accordance with the purpose of the present invention, a display device, which is capable of recording data, having a recorded data editing function includes a user input unit receiving a command for executing the recorded data editing function, a display unit displaying a progressive bar for each of at least two recorded data and a progressive bar for an edited recorded data to be newly created, and a control unit receiving selections of respective editing sections for the at least two recorded data, the control unit inserting the selected editing section in the progressive bar for the edited recorded data to be newly created.

Preferably, the display unit displays the progressive bar for each of the at least two recorded data and the progressive bar for the edited recorded data to be newly created on one image simultaneously.

Preferably, the control unit, if the selected editing sections are overlapped on the progressive bar for the edited recorded data to be newly created, displays an image for selecting a fade in/out function or an overlap editing function.

Preferably, the display device is a DVR (digital video recorder).

Preferably, the display unit displays a still image corresponding to the progressive bar.

To further achieve these and other advantages and in accordance with the purpose of the present invention, a display device, which is capable of recording data, having a recorded data editing function includes a display screen, if a command for executing the recorded data editing function is inputted, displaying a progressive bar for each of at least two recorded data, a progressive bar for an edited recorded data to be newly created, and a still image corresponding to each of the progressive bars, the display screen displaying respective editing sections for the at least two recorded data on the progressive bar for the edited recorded data to be newly created, the display screen, if the selected editing sections are overlapped on the progressive bar for the edited recorded data to be newly created, displaying an image for selecting a fade in/out function or an overlap editing function.

It is to be understood that both the foregoing general description and the following detailed description are exemplary and explanatory and are intended to provide further explanation of the invention as claimed.

### BRIEF DESCRIPTION OF THE DRAWINGS

FIG. 1 is an exemplary diagram of an editing image of a display device having a function of editing recorded data according to a related art.

FIG. 2 is a block diagram of a configuration of a display device having a function of editing recorded data according to the present invention.

FIG. 3 is an exemplary diagram of an editing image of a display device having a function of editing recorded data according to the present invention.

FIG. 4 is another exemplary diagram of an editing image of a display device having a function of editing recorded data according to the present invention.

FIG. 5A is a flowchart of a method for controlling a display device having a function of editing recorded data according to a first embodiment of the present invention.

FIG. 5B is an exemplary diagram of an editing image according to the first embodiment shown in FIG. 5A.

FIG. 6A is a flowchart of a method for controlling a display device having a function of editing recorded data according to a second embodiment of the present invention.

FIG. 6B is an exemplary diagram of an editing image according to the second embodiment shown in FIG. 6A.

FIG. 7A is a flowchart of a method for controlling a display device having a function of editing recorded data according to a third embodiment of the present invention.

FIG. 7B is an exemplary diagram of an editing image according to the third embodiment shown in FIG. 7A.

FIG. 8A is a flowchart of a method for controlling a display device having a function of editing recorded data according to a fourth embodiment of the present invention.

FIG. 8B is an exemplary diagram of an editing image according to the fourth embodiment shown in FIG. 8A.

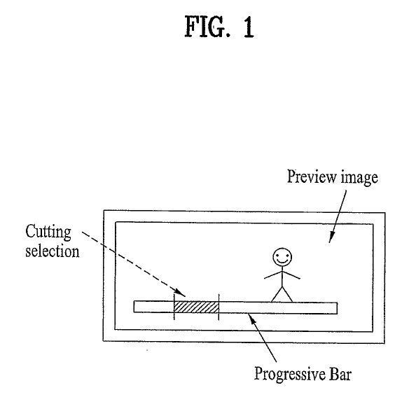

### BEST MODE FOR CARRYING OUT THE INVENTION

### Mode for Invention

Reference will now be made in detail to the preferred embodiments of the present invention, examples of which are illustrated in the accompanying drawings.

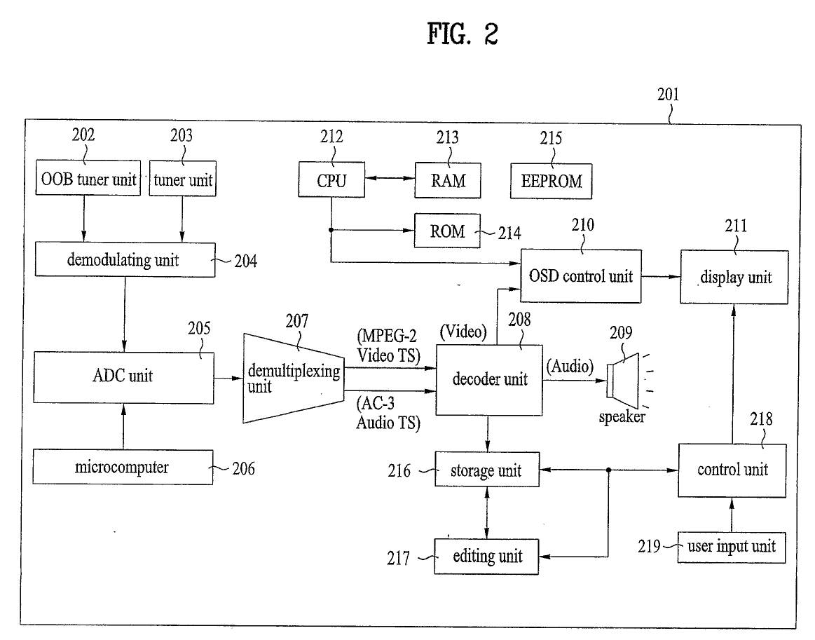

FIG. 2 is a block diagram of a configuration of a display device having a function of editing recorded data according to the present invention.

A method that elements within a display device implements a recorded data editing function according to the present invention is explained with reference to FIG. 2 as follows.

Referring to FIG. 2, a display device 201 according to the present invention includes an OOB tuner unit 202, an tuner unit 203, a demodulating unit 204, an ADC unit 205, a microcomputer 206, a demultiplexing unit 207, a decoder unit 208, a speaker 209, an OSD control unit 210, a display unit 211, a CPU 212, a RAM, a ROM 214, an EEPROM 215, a storage unit 216, an editing unit 217, a control unit 218, a user input unit 219, and the like.

The display device 201 can include one of a DTV (digital television, a PVR (personal video recorder), a DVR (digital video recorder), and the like.

The display device 201 is equipped with a function of receiving and recording data of movie and the like from a broadcasting station or an external input device (e.g., DVD player, etc.) and a function of editing recorded data (recorded material).

The OOB (out-of-band) tuner unit 202 plays a role in receiving a data broadcast from a cable broadcasting station or the like.

The tuner unit 203 plays a role in receiving normal A/V broadcast from a broadcasting station or the like. Meanwhile, the tuner unit 203 is called an in-band tuner unit, compared to the OOB tuner unit 202.

The demodulating unit 204 demodulates a broadcast signal transmitted via the tuner unit 203 in a modulated state.

If a broadcast signal received via the demodulating unit 204 is an analog broadcast signal, the ADC unit 205 converts the received broadcast signal to a digital signal under the control of the microcomputer 206.

The demultiplexing unit 207 demultiplexes the digital broadcast signal received via the ADC unit 205 into a video transport stream and an audio transport stream.

Yet, the video transport stream (video TS) can be video data compressed by MPEG-2 for example.

And, the audio transport stream (audio TS) can be audio data compressed by AC-3 for example.

The decoder unit 208 decodes the audio data separated by the demultiplexing unit 207 and then controls the decoded data to be outputted via the speaker 209.

And, the decoder unit 208 decodes the video data separated by the demultiplexing unit 207 and then controls the decoded data to be outputted via the OSD control unit 210 to the display unit 211.

The CPU (central processing unit) 212 plays a role in controlling the RAM 213, the ROM 214, the EEPROM 215, and the like.

The RAM 213 is an abbreviation of a random access memory. The RAM 213 includes a circuit for recording and a circuit for interpretation to enable recording and interpretation of information. And, the RAM 213 is widely used as a memory device for a video device, computer, a peripheral terminal, or the like.

The ROM (read only memory) 214 is a sort of a memory device. And, the ROM 214 is a memory capable of reading contents therein but incapable of changing the contents.

The ROM 214 is usually compared to a RAM (or, RWM) capable of both read and write. The ROM 214 is able to maintain the contents despite absence of power supplied to a display device or computer. So, the ROM 214 is generally used to load a basic operational system function or a language interpreter in a display device or computer.

The EEPROM (electrically erasable and programmable read only memory) 215 is a non-volatile memory device stably maintaining its memory for a long-term without power supply.

The EEPROM 215 is a modification of an EPROM (erasable and programmable read only memory) and is capable of erasing recorded data for rewrite.

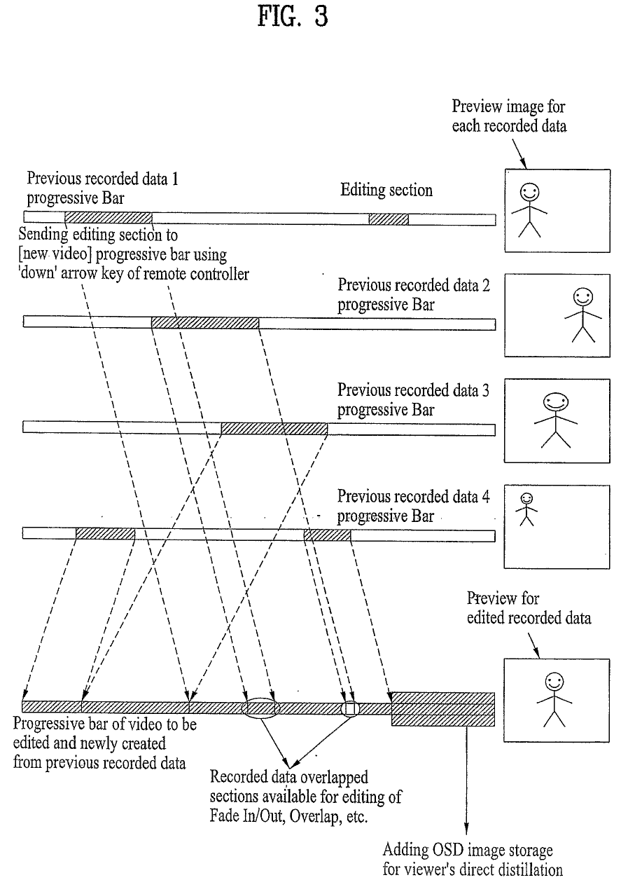

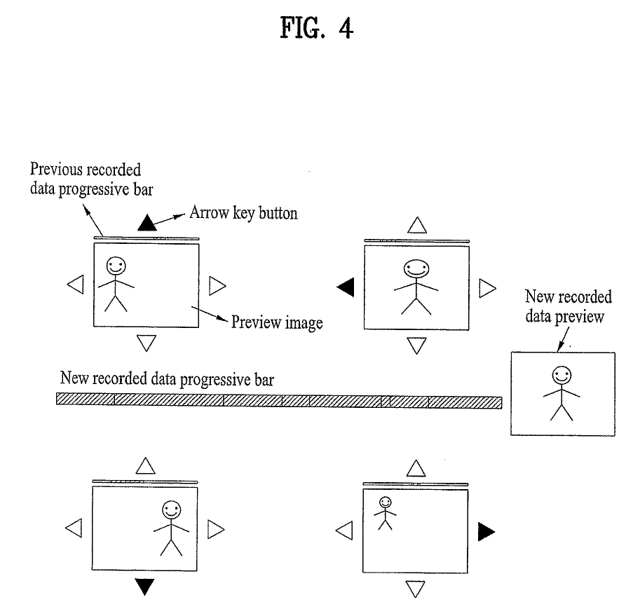

Two kinds of embodiments of the present invention are explained with reference to FIG. 3 and FIG. 4 as follows.

FIG. 3 is an exemplary diagram of an editing image of a display device having a function of editing recorded data according to the present invention.

An example of an editing image of a display device having a function of editing recorded data according to the present invention is explained with reference to FIG. 3 as follows.

First of all, if an input signal for executing a recorded data editing function is applied via the user input unit 219 or the like, the control unit 218 controls the display unit 211 to display an image shown in FIG. 3.

In this case, the user input unit 219 includes a remote controller or a local key button attached to the display device 201 for example.

The image shown in FIG. 3 includes progressive bars for a plurality of recorded data and preview images 301 for a plurality of the recorded data.

The preview image 301 can include a still image of an editing section for example.

A user can make an edited recorded data to be newly created from a plurality of the previously recorded data by selecting the progressive bar of the corresponding previously recorded data in a manner of manipulating an ‘up, down, right, and left’ arrow key button and a ‘confirm’ key button of the user input unit 219 with reference to the display image shown in FIG. 3.

The previously recorded data can include A/V data previously stored in the storage unit 216, a broadcast signal, or a signal inputted from an external device.

The user is able to select one of a plurality of the previously recorded data and the edited recorded data to be newly created by selecting the ‘up and down’ arrow key button of the user input unit 219.

And, the user is able to set an editing section within the previously recorded data using the ‘right and left’ arrow key button and the ‘confirm’ button of the user input unit 219.

Having set the editing section in the previously recorded data, the user presses the ‘down’ arrow key button of the user input unit 219 twice, it is copied and shifted to the progressive bar of the edited recorded data to be newly created.

Yet, the progressive bar of the edited recorded data to be newly created can be the progressive bar located at a lowest part among the several progressive bars shown in FIG. 3.

In the progressive bar of the edited recorded data to be newly created, the respective editing sections of the previously recorded data are stacked as long as their play lengths and in sequence.

The user is able to mutually overlap the editing sections included in the progressive bar of the edited recorded data to be newly created using the ‘right and left’ arrow key button and the ‘confirm’ button of the user input unit 219.

In the progressive bar of the edited recorded data to be newly created, if the editing sections are overlapped, the control unit 218 controls the display unit 211 to output a menu image for selecting a fade-in/out function or an overlap function.

Yet, the menu image can be displayed on the screen in a pop-up format for example.

The control unit 218 is able to control a video material, which was previously made and stored in the storage unit 216 by the user, to be inserted in the progressive bar of the edited recorded data to be newly created.

Optionally, the control unit 218 can control the display unit 211 to output the preview image on a right side of each of the progressive bars, thereby facilitating the recorded data editing.

In this case, the editing unit 217 performs a function of erasing or inserting the data stored in the storage unit 216 under the control of the control unit 218.

And, the control function of the control unit 218 can be controlled by the user via the user input unit 219.

Meanwhile, in the above explanation, the editing function is executed using the ‘up, down, right, and left’ arrow key button and the ‘confirm’ key button for example, which is included in the spirit and scope of the present invention. Thus, it is more apparent this should come within the scope of the appended claims.

FIG. 4 is another exemplary diagram of an editing image of a display device having a function of editing recorded data according to the present invention.

Another example of an editing image of a display device having a function of editing recorded data according to the present invention is explained with reference to FIG. 4 as follows.

First of all, if an input signal for executing a recorded data editing function is applied via the user input unit 219 or the like, the control unit 218 controls the display unit 211 to display an image shown in FIG. 4.

In this case, the user input unit 219 includes a remote controller or a local key button attached to the display device 201 for example.

According to the image shown in FIG. 4, a user is able to edit a plurality of previously recorded data into one recorded data by simple key button manipulations.

If the ‘up’ arrow key button of the user input unit 219 is pressed, a preview image of a currently edited recorded data is replaced by a preview image of ‘recent editing section start point’ of a different previously recorded data (cf. ‘preview image’ in left upper part of FIG. 4). Yet, the different previously recorded data can be the previously recorded data that was being edited in advance.

If the ‘left’ arrow key button of the user input unit 219 is pressed, it is shifted to a previous frame of the currently edited recorded data. Subsequently, if the ‘confirm’ key of the user input unit 219 is pressed, it is set to a start point of an editing section (cf. ‘preview image’ in right upper part of FIG. 4).

If the ‘right’ arrow key button of the user input unit 219 is pressed, it is shifted to a post frame of the currently edited recorded data. Subsequently, if the ‘confirm’ key of the user input unit 219 is pressed, it is set to an end point of an editing section (cf. ‘preview image’ in right upper part of FIG. 4).

If the ‘down’ arrow key button of the user input unit 219 is pressed, the preview image of the currently edited recorded data is replaced by a preview image of ‘recent editing section start point’ of a different previously recorded data (cf. ‘preview image’ in left lower part of FIG. 4). Yet, the different previously recorded data can be the previously recorded data that is selected as a next editing target.

According to one embodiment of the present invention, after completion of the configuration of the editing section, the display device is able to stack the editing sections of the respective recorded data on the progressive bar of the edited recorded data to be newly created.

Of course, a detailed editing process can be configured in a manner that the editing unit erases the data stored in the storage unit and inserts data under the control of the control unit.

And, the control function of the control unit 218 can be controlled by the user via the user input unit 219.

Meanwhile, in the above explanation, the editing function is executed using the ‘up, down, right, and left’ arrow key button and the ‘confirm’ key button for example, which is included in the spirit and scope of the present invention. Thus, it is more apparent this should come within the scope of the appended claims.

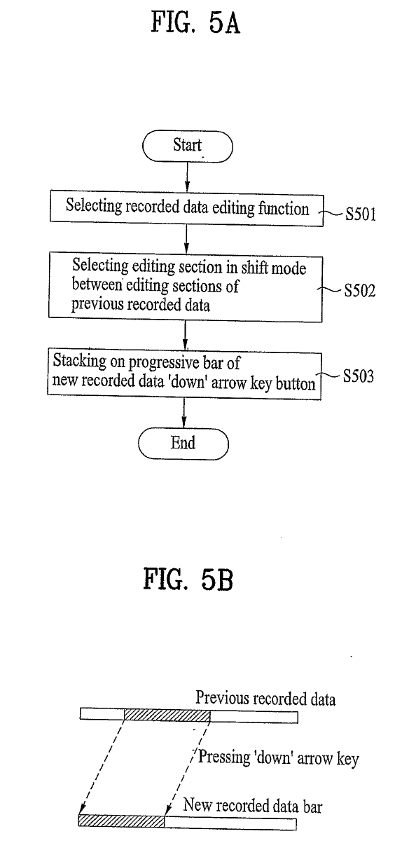

FIG. 5A is a flowchart of a method for controlling a display device having a function of editing recorded data according to a first embodiment of the present invention.

FIG. 5B is an exemplary diagram of an editing image according to the first embodiment shown in FIG. 5A.

A method of shifting an editing section of a previous recorded data to a progressive bar of an edited recorded data to be newly created is explained with reference to FIG. 5A and FIG. 5B as follows.

First of all, a user turns on a power of the display device and then selects a menu for executing a recorded data editing function (S501).

The user selects an editing section using ‘right and left’ arrow key button of a previous recorded data (S502).

After completion of the selection for the editing section, if the user presses ‘down’ arrow key button, the selected editing section is stacked on the progressive bar of the edited recorded data to be newly created (S503).

According to the flowchart shown in FIG. 5A, if the recorded data editing function is executed, an image shown in FIG. 5B can be outputted for example.

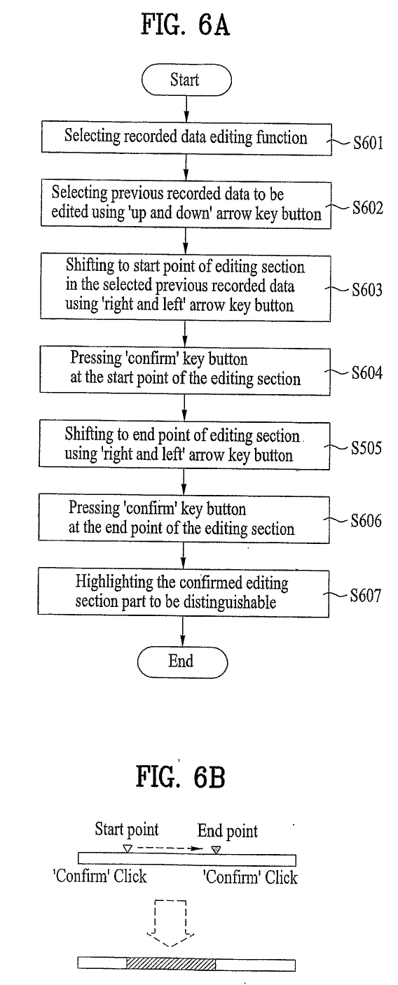

FIG. 6A is a flowchart of a method for controlling a display device having a function of editing recorded data according to a second embodiment of the present invention.

FIG. 6B is an exemplary diagram of an editing image according to the second embodiment shown in FIG. 6A.

A method of selecting an editing section from a progressive bar of a previous recorded data is explained with reference to FIG. 6A and FIG. 6B as follows.

First of all, a user turns on a power of the display device and then selects a menu for executing a recorded data editing function (S601).

The user selects a previous recorded data to edit using the ‘up and down’ arrow key button or the like (S602) Yet, it can be assumed that the image shown in FIG. 3 has been already outputted for example.

It is then shifted to a start point of a section to be edited on the selected previous recorded data using the ‘right and left’ arrow key button or the like (S603).

The user presses the ‘confirm’ key button or the like at the start point of the section to be edited (S604).

It is then shifted to an end point of the section to be edited again using the ‘right and left’ arrow key button or the like (S605).

The user then presses the ‘confirm’ key button or the like at the end point of the section to be edited (S606).

The display device highlights the confirmed editing section part to be displayed distinguishable from other parts (S607).

According to the flowchart shown in FIG. 6A, if the recorded data editing function is executed, an image shown in FIG. 6B can be outputted for example.

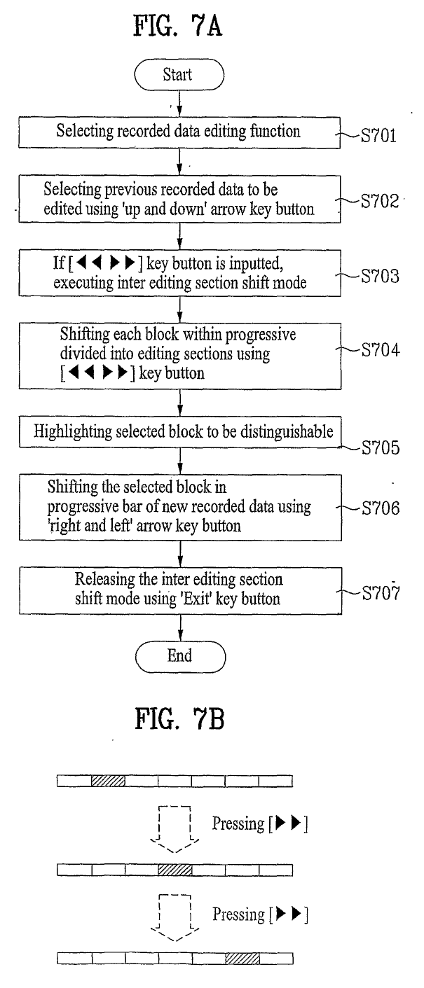

FIG. 7A is a flowchart of a method for controlling a display device having a function of editing recorded data according to a third embodiment of the present invention.

FIG. 7B is an exemplary diagram of an editing image according to the third embodiment shown in FIG. 7A.

A method of a shift per an editing section in a recorded data is explained with reference to FIG. 7A and FIG. 7B as follows.

First of all, a user turns on a power of the display device and then selects a menu for executing a recorded data editing function (S701).

The user selects a previous recorded data to edit using the ‘up and down’ arrow key button or the like (S702). Yet, it can be assumed that the image shown in FIG. 3 has been already outputted for example.

In the selected recorded data, if an input of a ‘rewind’ key button ( [symbol] ) or a ‘forward’ key button ( [symbol] ) is inputted, the display device decides that an editing section inter-block shift mode is entered (S703).

In particular, in a progressive bar constructed with at least one editing section block, if the input of the ‘rewind’ key button ( [symbol] ) or the ‘forward’ key button ( [symbol] ) is inputted, a shift is made by block unit (S704).

The display device highlights the block selected by an input of the ‘confirm’ key button or the like to be displayed distinguishable from other blocks (S705).

Furthermore, the user is able to shift the selected block itself by pressing the ‘right and left’ arrow key button or the like while the block is highlighted (S706).

If the user presses an ‘exit’ key button or the like, the display device releases the editing section inter-block mode (S707).

According to the flowchart shown in FIG. 7A, if the recorded data editing function is executed, an image shown in FIG. 7B can be outputted for example.

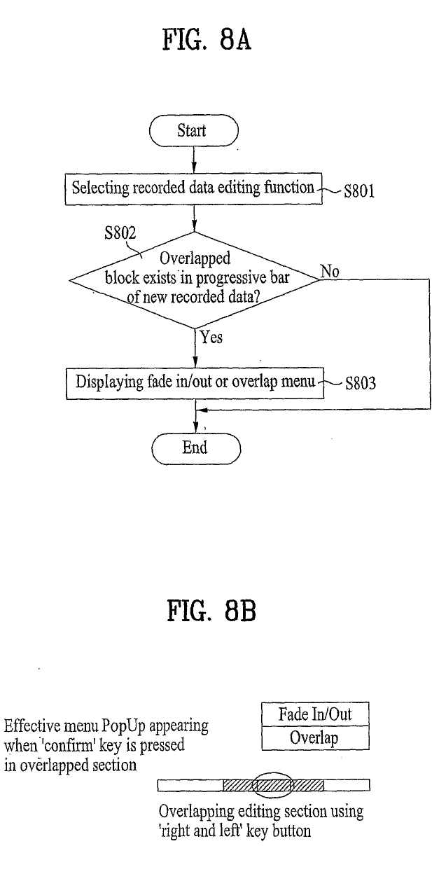

FIG. 8A is a flowchart of a method for controlling a display device having a function of editing recorded data according to a fourth embodiment of the present invention.

FIG. 8B is an exemplary diagram of an editing image according to the fourth embodiment shown in FIG. 8A.

A method of if there exists an overlapped block exist, displaying the overlapped block differently in correspondence to user's preference is explained with reference to FIG. 8A and FIG. 8B as follows.

First of all, a user turns on a power of the display device and then selects a menu for executing a recorded data editing function (S801).

The display device decides whether an overlapped block exists in a progressive bar of an edited recorded data to be newly created (S802).

As a result of the decision S802, if the overlapped block exists, the display device displays a menu image for selecting a fade in/out function or an overlap function (S803). The user is able to select one of the fade in/out function or the overlap function to make the overlapped block faded in/out or overlapped.

According to the flowchart shown in FIG. 8A, if the recorded data editing function is executed, an image shown in FIG. 8B can be outputted for example.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

Accordingly, effects of the display device having the function of editing the recorded data and the method for controlling the same according to the present invention are explained as follows.

First of all, a display device of the present invention is capable of editing a plurality of recorded data in a more convenient manner with simple manipulation.

For instance, while progressive bars and preview images for at least two previous recorded data are displayed, by comparing them, a user is able to select a specific editing section only with ease.

Moreover, as soon as the completion of the editing section selection, the editing section is automatically stacked on a progressive bar of an edited recorded data to be newly created. Hence, the display device of the present invention facilitates a user to perform editing.

Secondly, the present invention increases the number of previous recorded data, which can be simultaneously edited by a user, considerably greater than that of the related art.

Thirdly, the present invention enables various user-specific editing functions to be implemented.

What is claimed is:

1. In controlling a display device capable of recording data, a method of controlling the display device having a recorded data editing function, the method comprising the steps of:
receiving a command for executing the recorded data editing function;
displaying a progressive bar for each of at least two recorded data and a progressive bar for an edited recorded data to be newly created;
selecting editing sections for the at least two recorded data, respectively; and
inserting the selected editing section in the progressive bar for the edited recorded data to be newly created.

2. The method of claim 1, wherein the step of displaying the progressive bar for each of the at least two recorded data and the progressive bar for the edited recorded data to be newly created is characterized in displaying the progressive bars on one image simultaneously.

3. The method of claim 1, the step of selecting the editing sections for the at least two recorded data respectively, comprising the step of selecting the editing section for the at least two recorded data respectively via selection inputs of an arrow key button and a confirm key button included in a prescribed user input unit.

4. The method of claim 3, the step of selecting the editing section for the at least two recorded data respectively via the selection inputs of the arrow key button and the confirm key button included in the user input unit, comprising the steps of:
selecting one of the at least two recorded data via the selection inputs of the arrow key button and the confirm key button included in the user input unit; and
selecting the editing section for the selected recorded data via the selection inputs of the arrow key button and the confirm key button included in the user input unit.

5. The method of claim 1, the step of inserting the selected editing section in the progressive bar for the edited recorded data to be newly created, further comprising the step of if the selected editing sections are overlapped on the progressive bar for the edited recorded data to be newly created, displaying an image for selecting a fade in/out function or an overlap editing function.

6. The method of claim 5, further comprising the step of if a user selects the fade in/out or overlap editing function, fading in/out or overlapping the overlapped editing sections.

7. The method of claim 1, the step of displaying the progressive bar for each of the at least two recorded data and the progressive bar for the edited recorded data to be newly created, comprising the step of displaying a still image corresponding to the progressive bar.

8. A display device, which is capable of recording data, the display device having a recorded data editing function; the display device comprising:
a user input unit receiving a command for executing the recorded data editing function;
a display unit displaying a progressive bar for each of at least two recorded data and a progressive bar for an edited recorded data to be newly created; and
a control unit receiving selections of respective editing sections for the at least two recorded data, the control unit inserting the selected editing section in the progressive bar for the edited recorded data to be newly created.

9. The display device of claim 8, wherein the display unit displays the progressive bar for each of the at least two recorded data and the progressive bar for the edited recorded data to be newly created on one image simultaneously.

10. The display device of claim 8, wherein the control unit, if the selected editing sections are overlapped on the progressive bar for the edited recorded data to be newly created, displays an image for selecting a fade in/out function or an overlap editing function.

11. The display device of claim 8, wherein the display device is a DVR (digital video recorder).

12. The display device of claim 8, wherein the display unit displays a still image corresponding to the progressive bar.

13. The display device of claim 10, wherein if a user selects the fade in/out or overlap editing function, the control unit fades in/out or overlaps the overlapped editing sections.

14. A display device, which is capable of recording data, the display device having a recorded data editing function, the display device includes a display screen, if a command for executing the recorded data editing function is inputted, displaying a progressive bar for each of at least two recorded data, a progressive bar for an edited recorded data to be newly created, and a still image corresponding to each of the progressive bars, the display screen displaying respective editing sections for the at least two recorded data on the progressive bar for the edited recorded data to be newly created, the display screen, if the selected editing sections are overlapped on the progressive bar for the edited recorded data to be newly created, displaying an image for selecting a fade in/out function or an overlap editing function.

15. The display device of claim 14, wherein the display screen, if a user selects the fade in/out or overlap editing function, fades in/out or overlaps the overlapped editing sections.
